(19) United States
(12) Patent Application Publication
(10) Pub. No.: US 2008/0260532 A1
(43) Pub. Date: Oct. 23, 2008

(54) Vertical Axis Turbine

(76) Inventor: Matthew Luethi, Kent (GB)

Correspondence Address: FAY SHARPE LLP, 1100 SUPERIOR AVENUE, SEVENTH FLOOR, CLEVELAND, OH, 44114, US

(21) Appl. No.: 11/791,868

(22) PCT Filed: Nov. 23, 2005
(86) PCT No.: PCT/GB05/50212

§ 371 Date: Mar. 25, 2008

(30) Foreign Application Priority Data
Nov. 24, 2004 (GB) 04258273

(51) Int. Cl. F03D 3/06; F03D 7/06; F03D 9/00

(52) U.S. Cl. 416/51; 290/55

(57) ABSTRACT

A turbine with a vertical axis of rotation is described, with particular reference to a wind powered embodiment. It is advantageous to ensure that a turbine rotates at a substantially constant speed despite variations in the driving force and to ensure that the turbine is not damaged when the driving force is excessive. The turbine includes a plurality of turbine blades arranged about a central axis, with each turbine blade being pivotally mounted towards its outer periphery about an axis substantially parallel to the central axis. A biasing element biases the inner periphery of the turbine blades towards the central axis. As the speed of rotation of the turbine increases, the blades swing out of the wind and there center of gravity moves away from the central axis, tending to slow the speed of rotation.

The present invention relates to a turbine with a vertical axis of rotation and particularly to a wind powered turbine with a built in speed regulator.

Wind-powered turbines conventionally comprise a plurality of sails or blades placed radially around a shaft. The sails or blades are appropriately shaped and positioned relative to an air flow so that, in operation, the force produced by the air flow impacting the turbine causes the shaft to rotate. Historically, this rotational movement was used to grind corn or pump water but it is now commonly used to generate electricity.

Wind powered turbines with a vertical axis provide certain advantages over wind powered turbines with a horizontal axis of rotation. For example, the blades extend horizontally, reducing the need for the rotor to be placed on a tall tower above the ground; the weight of shaft and blades can be evenly applied to the bearings supporting the shaft preventing excess wear at the bottom of horizontal bearings; and in certain embodiments, operation can be independent of the wind direction.

However, as with all wind powered turbines, there is a danger that in high winds the turbine blades may be damaged. Furthermore, it is advantageous for the shaft of a wind powered turbine to rotate at a substantially constant speed, as far as possible, regardless of the strength of the wind. Accordingly, it is an aim of the present invention to provide a mechanism whereby the blades of a wind powered turbine are protected from high winds and further to assist in maintaining the rotation of the turbine shaft at a substantially constant speed, regardless of the strength of the wind.

Accordingly, the present invention provides a turbine comprising: a plurality of turbine blades arranged about a substantially vertical central axis such that they can rotate together about the central axis, each turbine blade having a outer edge and an inner edge and being pivotally mounted near the outer edge about an axis substantially parallel to the central axis; and biasing means which biases the inner edge of each turbine blade towards the central axis, wherein: when the turbine blades are placed in a fluid flow they rotate together about the central axis and, as their speed of rotation increases, they pivot about their mountings against the bias of the biasing means and into a more circumferential orientation about the central axis; and the biasing means further comprises: a mass positioned substantially on the central axis and axially movable with respect thereto and connected with each turbine blade near its inner edge, wherein, as the speed of rotation of the turbine increases and turbine blades pivot about their mountings, the mass is lifted along the central axis.

Preferably, the speed of rotation is reduced as a result of the centre of gravity of the turbine blades moving away from the axis of rotation as they pivot about their mountings. Preferably, the speed of rotation is reduced as a result of the turbine blades moving out of the fluid flow as they pivot about their mountings.

Preferably, the turbine further comprises a shaft positioned along the central axis. Preferably, the mass is in the form of a collar positioned around the main shaft.

Preferably, the turbine further comprising a blade frame on which the turbine blades are mounted, spanning from the central axis. Preferably, each turbine blade comprises a substantially rectangular sheet with a curved profile. Preferably, each turbine blade has a concave face that is roughened or coated with a rough material. Preferably, each turbine blade has additional mass disposed towards its inner edge.

Preferably, the turbine is wind powered. Preferably, the turbine is used to generate electricity.

Specific embodiments of the invention will now be described by way of example with reference to the accompanying drawings in which:

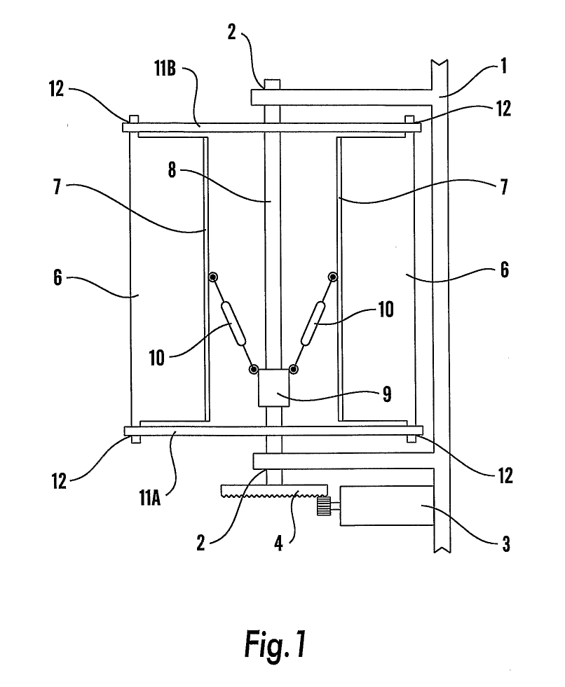

FIG. 1 is a diagrammatic side view of a turbine with the blades nearest the viewer removed for clarity;

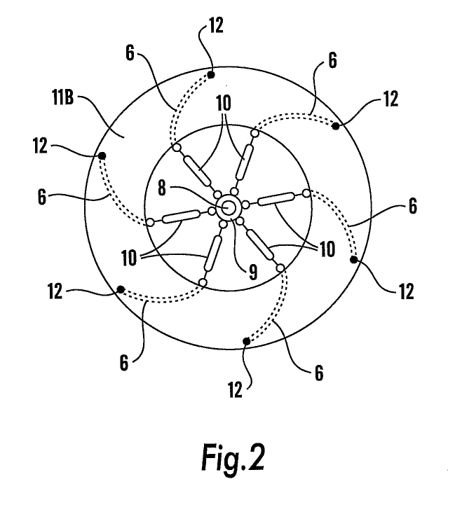

FIG. 2 is a diagrammatic top view of the turbine;

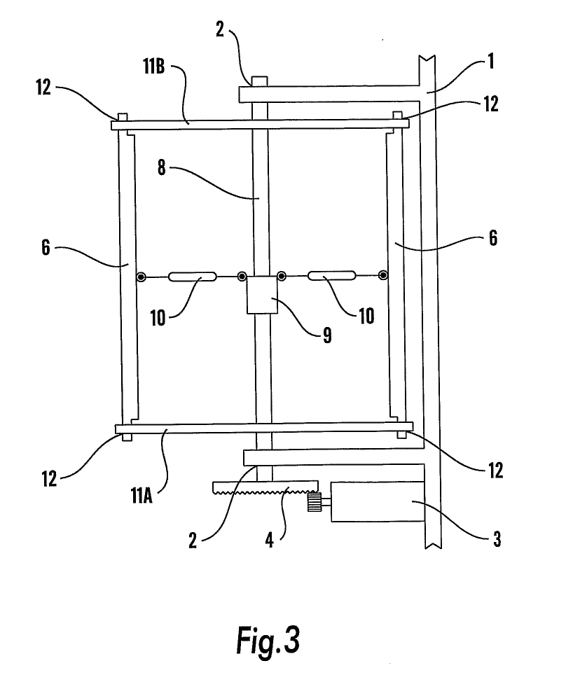

FIG. 3 is a diagrammatic view corresponding to FIG. 1 when the turbine is rotating at high speed; and

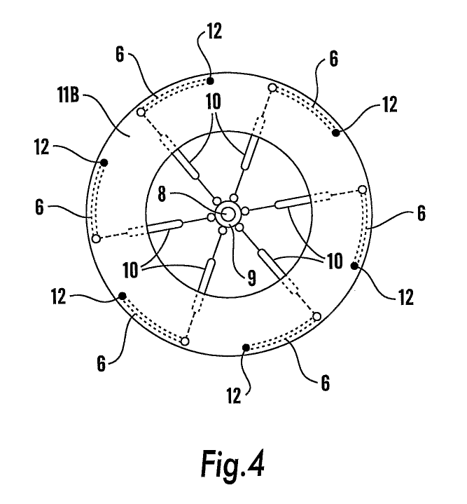

FIG. 4 is a diagrammatic view corresponding to FIG. 2 when the turbine is rotating at high speed.

As shown in the Figures, an embodiment of the turbine includes a vertical main shaft 8, supported by a frame 1 via main bearings 2. The shaft 8 is rotatable about its axis. A lower blade support 11A, comprising a metal ring, is attached by a pair of radial arms to the main shaft 8 and a similar upper blade support 11B is attached higher up the main shaft 8. A plurality of turbine blades 6 are disposed between the lower blade support 11A and the upper blade support 11B. The embodiment shown has six turbine blades 6 but any number of blades 6 may be used according to design choice. Each blade comprises a substantially rectangular plate of metal with a curved profile. Each blade is pivotally mounted towards its outer periphery in a bearing 12 positioned towards the outer circumference of the lower blade support 11A and is supported in a substantially vertical position by a corresponding bearing 12 in the upper blade support 11B. Each blade 6 is therefore hinged and can pivot around its mountings between an orientation substantially around a circle centred on the main shaft 8 and an orientation substantially radial to the main shaft 8. Each turbine blade 6 has reinforcement in the form of a vertical strut 7 positioned along its inner edge. The mass of the vertical strut 7 serves to position the centre of gravity of each turbine blade 6 towards the centre of the turbine.

The turbine blades 6 are biased towards a substantially radial orientation by means of a mass 9, in the form of a collar around the vertical shaft 8. The mass 9 is free to move along the axis of the vertical shaft 8. Each turbine blade 6 is coupled to the mass 9 by a link 10 attached towards the inner periphery of the turbine blade 6. Couplings are provided at each end of each link 10 providing two degrees of freedom so as to enable movement of the mass 9 along the axis of the vertical shaft 8 and linked movement of the blades from a substantially circumferential orientation to a substantially radial orientation around the vertical shaft 8. The link 10 may be of fixed length and may include an adjusting means for appropriately adjusting the length of the link 10 prior to use. Alternatively, the link 10 may be in the form of a strong spring.

The turbine is connected via a gearing arrangement 4 to a generator/alternator 3 for generating electricity.

One skilled in the art will quickly conceive of many alternative arrangements that fall within the scope of the present invention. The central portion of the main shaft 8 may be omitted, such that the turbine is held together between the frame 1, with the lower frame support 11A and the upper frame support 11B being held apart by the turbine blades 6. The main shaft 8 might be rigidly fixed to the frame 1 with bearings allowing rotation of the blade supports around the shaft 8. Struts may be disposed between the frame supports towards their outer periphery and rigidly fixed thereto with the turbine blades 6 being attached to the struts by conventional hinges. The turbine blades 6 of the described embodiment have a shallow “C” shaped profile but an “S” shaped profile or any other profile suitable for catching the wind from one direction only may be used. Turbine blades 6 with a flat profile may also be used, preferably in conjunction with appropriate cowling to direct the wind to one side of the blades 6 only. The concave face of the turbine blades 6 may be roughened or coated with a rough material to help catch the wind.

In the absence of a central shaft 8, the mass 9 no longer need be in the shape of a collar, although it is considered advantageous to guide its movement along the central axis of the turbine.

The turbine has uses other than the generation of electricity, although this provides a convenient means for transmission of power. For example, it could be used to drive mechanical machinery directly.

In one embodiment, the turbine may include a braking system (not shown) to slow or stop the rotation of the turbine when desired. This may take the form or a conventional disk break disposed around the main shaft 8.

In use, the turbine is placed in a fluid flow, preferably an air-flow or wind. The turbine blades 6 are preferably shaped such that the direction of the wind is immaterial. Wind impacting a concave surface of the blade will generate a force on the turbine blade tending to push the blade in the direction that the wind is flowing. Wind impacting the convex surface of the turbine blades 6 on the opposite side of the turbine will generate a similar but smaller force. The result will be rotation of the turbine around its central axis. For example, the turbine shown in FIGS. 2 and 4 will rotate in an anti-clockwise direction. Clearly if the prevailing wind direction is known, appropriate cowling (not shown) can be provided to increase the wind impacting the concave surfaces of the turbine and decrease the wind impacting the convex surfaces.

As the turbine rotates, the turbine blades tend to spin outwards as a result of the centrifugal forces acting on them and lift the mass 9 up the main shaft 8. This configuration is shown in FIGS. 3 and 4. The movement of the turbine blades 6 has two important effects. As the mass of the turbine blades 6 moves outwards, the speed of rotation of the turbine will tend to reduce in the same way that a governor on an engine maintains it speed, or a spinning ice skater slows down as she moves her centre of gravity radially outwards. Secondly, as the blades move to a more circumferential orientation, they catch less wind, thereby reducing the accelerating force provided to them by the wind. In the extreme, the turbine blades 6 move to a circumferential orientation completely out of the wind, thereby protecting the turbine from high winds or sudden gusts. The heavier the mass 9, the faster the turbine will spin and the larger the gust necessary to move the turbine blades 6 out of the wind. Although this invention is described with reference to a wind-powered turbine, the principles described herein can be used in relation to turbines powered by other fluids, particularly water powered turbines.

One skilled in the art will readily conceive of many alternative embodiments of the invention described above. The present invention includes all such alternatives which fall within the scope of the following claims.

1. A turbine comprising:
a plurality of turbine blades arranged about a substantially vertical central axis such that they can rotate together about the central axis, each turbine blade having an outer edge and an inner edge and being pivotally mounted near the outer edge about an axis substantially parallel to the central axis; and
biasing means which biases the inner edge of each turbine blade (6) towards the central axis, wherein: when the turbine blades are placed in a fluid flow they rotate together about the central axis and, as their speed of rotation increases, they pivot about their mountings against the bias of the biasing means and into a more circumferential orientation about the central axis; and
the biasing means further comprises:
a mass positioned substantially on the central axis and axially movable with respect thereto and connected with each turbine blade near its inner edge, wherein, as the speed of rotation of the turbine increases and turbine blades pivot about their mountings the mass is lifted along the central axis.

2. A turbine according to claim 1, wherein the speed of rotation is reduced as a result of the centre of gravity of the turbine blades moving away from the axis of rotation as they pivot about their mountings.

3. A turbine according to claim 1, wherein the speed of rotation is reduced as a result of the turbine blades moving out of the fluid flow as they pivot about their mountings.

4. A turbine according to claim 1, further comprising a shaft positioned along the central axis.

5. A turbine according to claim 4, wherein the mass is in the form of a collar positioned around the main shaft.

6. A turbine according to claim 1, further comprising a blade frame on which the turbine blades are mounted, spanning from the central axis.

7. A turbine according to claim 1, wherein each turbine blade comprises a substantially rectangular sheet with a curved profile.

8. A turbine according to claim 1, wherein each turbine blade has a concave face that is roughened or coated with a rough material.

9. A turbine according to claim 1, wherein each turbine blade has additional mass disposed towards its inner edge.

10. A turbine according to claim 1, wherein the fluid flow is a wind.

11. A turbine according to claim 1, further comprising a generator to generate electricity when driven by the turbine blades.

12. A wind-powered electricity generator comprising a turbine as claimed in claim 1.

13. A turbine comprising:
a plurality of turbine blades arranged about a substantially vertical central axis such that they can rotate together about the central axis, each turbine blade having an outer edge and an inner edge and being pivotally mounted near the outer edge about an axis substantially parallel to the central axis; and
a biasing element which biases the inner edge of each turbine blade towards the central axis, the biasing element comprising a mass positioned substantially on the central axis and axially movable with respect thereto and connected with each turbine blade near its inner edge; and,
wherein when the turbine blades are placed in a fluid flow they rotate together about the central axis and, as their speed of rotation increases, they pivot about their mountings against the bias of the biasing elements and into a more circumferential orientation about the central axis and the mass is lifted along the central axis.

14. The turbine according to claim 13, further comprising a shaft positioned along the central axis.

15. The turbine according to claim 14, wherein the mass is in the form of a collar positioned around the main shaft.

16. The turbine according to claim 13, further comprising a blade frame on which the turbine blades are mounted, spanning from the central axis.

17. The turbine according to claim 13, wherein each turbine blade comprises a substantially rectangular sheet with a curved profile.

18. The turbine according to claim 13, wherein each turbine blade has a concave face that is roughened or coated with a rough material.

19. The turbine according to claim 13, wherein each turbine blade has an additional mass disposed towards its inner edge.
